(19) United States
(12) Patent Application Publication
(10) Pub. No.: US 2016/0098422 A1
(43) Pub. Date: Apr. 7, 2016

(54) FILE ACCESSING SYSTEM AND FILE ACCESSING METHOD THEREOF

(71) Applicant: Institute For Information Industry, Taipei (TW)

(72) Inventors: Nien-I HSU, Puli Township (TW); Tseng-Yi CHEN, Taoyuan City (TW); Yuan-Hao CHANG, Taipei City (TW); Hsin Wen WEI, Zhubei City (TW); Wei-Kuan SHIH, New Taipei City (TW); Chia-Heng TU, New Taipei City (TW)

(21) Appl. No.: 14/566,635

(22) Filed: Dec. 10, 2014

(30) Foreign Application Priority Data
Oct. 3, 2014 (TW) 103134491

(51) Int. Cl. G06F 17/30; G06F 21/62

(52) U.S. Cl. CPC G06F 17/30171; G06F 21/6218

(57) ABSTRACT

A file accessing system and a file accessing method thereof are provided. The file accessing system includes a storing unit and a processing unit. The storing unit stores a file accessing table which has a file record item. The file record item has a block point field and a key field. The processing unit: decides a storing block and a key of a file, where the storing block stores a data record table having a data record item which has a corresponding key field and a data allocation field; records a block identification of the storing block and the key into the block point field and the key field respectively; stores the file into a segment of the storing block; and records the key and the segment into the corresponding key field and the data allocation field respectively.

### PRIORITY

This application claims priority to Taiwan Patent Application No. 103134491 filed on Oct. 3, 2014, which is hereby incorporated by reference herein in its entirety.

### FIELD

The present invention relates to a file accessing system and a file accessing method thereof, and more particularly, the file accessing system and the file accessing method thereof according to the present invention dynamically stores a file or a tail of a file into blocks mainly by use of a data table.

### BACKGROUND

In the prior art, files in different file system architectures are accessed by means of respective file system properties. Specifically, if there is a file that needs to be stored, firstly an adequate number of data storing blocks are chosen for the file according to settings of a storing device in the file system before the file is to be stored and subsequently to be read.

However, sizes of the data storing blocks in the conventional file systems are fixed early at the system setting stage and cannot be changed thereafter. Therefore, in case of a file having a size that just exceeds the size of one storing block (or a multiple thereof), the system allocates an additional data storing block to this file. In this case, because the additional allocated data storing block is used to store a small amount of data and the remaining space cannot be used for other files, a waste of the space would be caused when the number of such files and probabilities of using this storage mechanism increase.

Although there are some file systems that use storing blocks of different sizes to solve the aforesaid problems, such a scheme makes the file management inconvenient and, besides, is still unable to avoid the problem of leading to a poor space utilization factor in the conventional file systems when a file of a specific size is to be stored.

Accordingly, an urgent need exists in the art to provide a novel file system architecture in which a more efficient file accessing mechanism is used to improve the space utilization factor of the storing device and the file accessing efficiency and to make an improvement on the drawbacks of the prior art.

### SUMMARY

A primary objective of the present invention includes providing a file accessing method for a file accessing system. The file accessing system stores a file accessing table. The file accessing table has a first file record item. The first file record item has a first block point field and a first key field. The file accessing method comprises the following steps of: (a) enabling the file accessing system to decide a first storing block and a first key for a file, wherein the first storing block stores a first data record table having a first data record item, and the first data record item has a first corresponding key field and a first data allocation field; (b) enabling the file accessing system to record a first block identification of the first storing block and the first key into the first block point field and the first key field respectively; (c) enabling the file accessing system to store the file into a first segment of the first storing block; and (d) enabling the file accessing system to record the first key and the first segment into the first corresponding key field and the first data allocation field respectively.

To achieve the aforesaid objective, in certain embodiments the present invention includes a file accessing system, which comprises a storing unit and a processing unit. The storing unit stores a file accessing table. The file accessing table has a first file record item. The first file record item has a first block point field and a first key field. The processing unit is configured to: decide a first storing block and a first key in the storing unit for a file, wherein the first storing block stores a first data record table having a first data record item, and the first data record item has a first corresponding key field and a first data allocation field; record a first block identification of the first storing block and the first key into the first block point field and the first key field respectively; store the file into a first segment of the first storing block; and record the first key and the first segment into the first corresponding key field and the first data allocation field respectively.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a block diagram of a file accessing system according to a first embodiment of the present invention;

FIG. 1B is a schematic view illustrating operations of the file accessing system according to the first embodiment of the present invention;

FIG. 2 is a schematic view illustrating operations of a file accessing system according to a second embodiment of the present invention;

FIG. 3 is a schematic view illustrating operations of a file accessing system according to a third embodiment of the present invention;

FIG. 4 is a schematic view illustrating operations of a file accessing system according to a fourth embodiment of the present invention;

FIGS. 5A-5B are flowchart diagrams of a file accessing method according to a fifth embodiment of the present invention; and

FIGS. 6A-6C are flowchart diagrams of a file accessing method according to a sixth embodiment of the present invention.

### DETAILED DESCRIPTION

Hereinbelow, the present invention will be explained with reference to example embodiments thereof. However, these example embodiments are not intended to limit the present invention to any specific embodiments, examples, environment, applications or implementations as described in these example embodiments. Therefore, description of the following example embodiments is only for purpose of illustration rather than to limit the present invention.

In the following embodiments and drawings, elements not directly related to the present invention are omitted from depiction; and dimensional relationships among individual elements in the following drawings are illustrated only for ease of understanding but not to limit the actual scale.

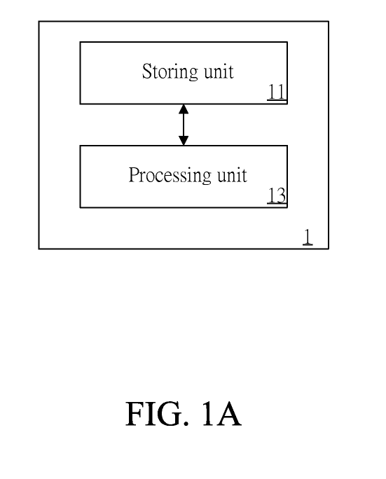

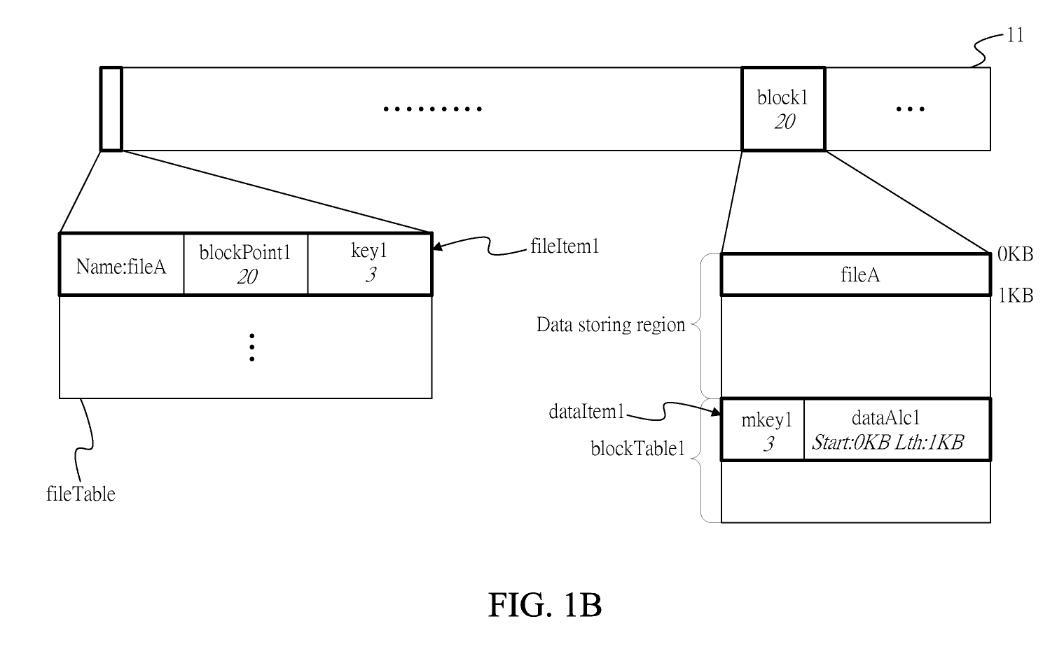

Please refer to FIGS. 1A-1B together. FIG. 1A is a block diagram of a file accessing system 1 according to a first embodiment of the present invention. FIG. 1B is a schematic view illustrating operations of the file accessing system 1 according to the first embodiment of the present invention. The file accessing system 1 comprises a storing unit 11 and a processing unit 13. The storing unit 11 stores a file accessing table fileTable. The file accessing table fileTable has a first file record item fileItem1. The first file record item fileItem1 has a first block point field blockPoint1 and a first key field key1. The file accessing process will be further detailed hereinbelow.

Firstly, when a file fileA whose size is smaller than that of a preset storing block needs to be stored, the processing unit 13 firstly determines a first storing block block1 and a first key in the storing unit 11 for the file fileA. The first storing block block1 stores a first data record table blockTable1. The first data record table blockTable1 has a first data record item dataItem1. The first data record item dataItem1 has a first corresponding key field mKey1 and a first data allocation field dataAlc1.

In the first embodiment, the first storing block block1 chosen by the processing unit 13 for the file fileA is a physical storing block having a first block identification with a value of 20, and the first key has a value of 3. Accordingly, the processing unit 13 records the first block identification of the first storing block block1 and the first key into the first block point field blockPoint1 and the first key field key1 respectively.

Then, the processing unit 13 firstly stores the file fileA into a first segment (starting from 0 KB and having a length of 1 KB) of the data storing region of the first storing block, and records the content of the first key and the first segment into the first corresponding key field mKey1 and the first data allocation field dataAlc1 respectively at the same time. In this way, the file fileA can be read through the aforesaid storing mechanism subsequently.

Further speaking, if the file fileA is to be read after the storing of the file fileA is completed, the processing unit 13 firstly accesses the first data record table blockTable1 of the first storing block block1 having an identification value of 20 according to the first block identification recorded in the first block point field blcokPoint1.

Then, the processing unit 13 accesses the first data allocation field dataAlc1 corresponding to the first corresponding key field, which also has a value of 3, according to the first key recorded in the first key field key1. Because the first data allocation field dataAlc1 records the first segment starting from 0 KB and having a length of 1 KB, the processing unit 13 can read the file fileA stored in the first segment of the first storing block block1.

It should be particularly appreciated that, the aforesaid fileA may also be considered as a tail-of-file portion of a large file whose size is larger than that of the preset storing block; and those skilled in the art can readily understand how to access the tail-of-file portion fileA of the large file in the same manner, so this will not be further described herein.

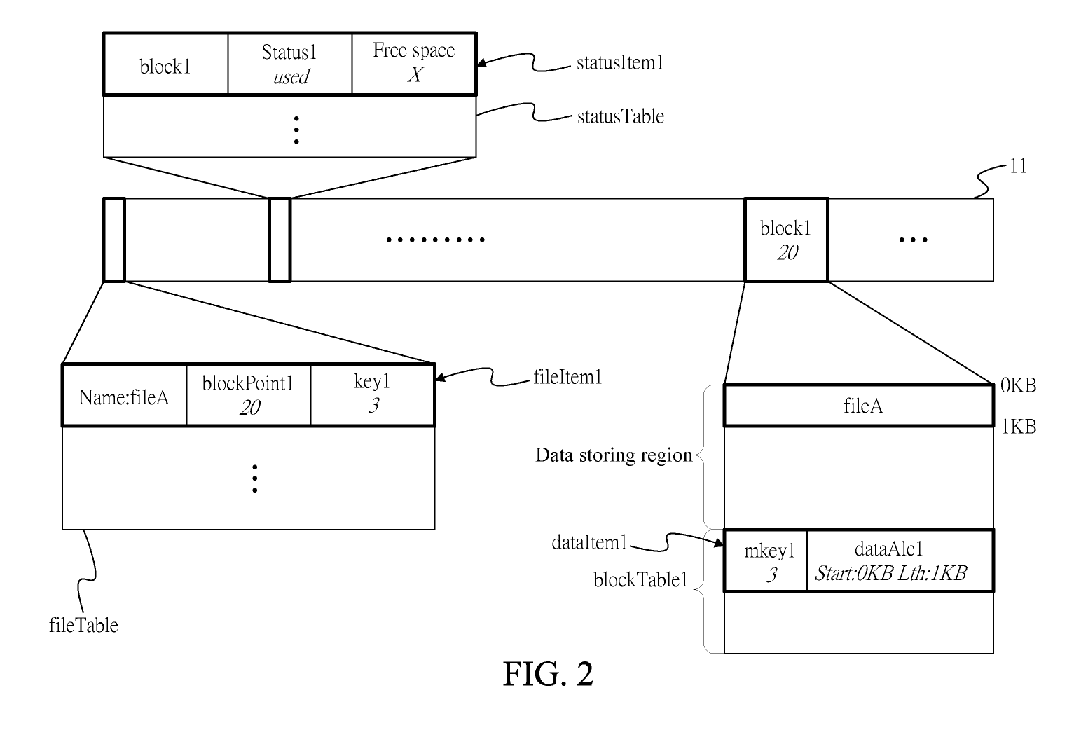

Referring to FIG. 2, there is shown a schematic view illustrating operations of the file accessing system 1 according to a second embodiment of the present invention. It should be particularly appreciated that, the second embodiment has the same architecture as the aforesaid embodiment, so elements bearing the same reference numerals also have the same functions and will not be further described herein. The second embodiment is mainly used to further describe how to choose a block.

Specifically, in the second embodiment, the storing unit 11 further stores a block usage status table statusTable. The block usage status table statusTable1 has a first block usage status item statusItem1. The first block usage status item statusItem1 records a first usage status status1 of the first storing block block1.

Accordingly, when the first usage status status1 mainly records that the first storing block block1 has already been used but still has an available space X, the processing unit 13 can determine whether the available space X of the first storing block block1 is large enough to store the file fileA. If the determination result is “yes”, then the processing unit 13 decides the first storing block block1 for the file fileA according to the first usage status status1. Otherwise, the processing unit 13 continues to search for an available storing block according to the block usage status table statusTable.

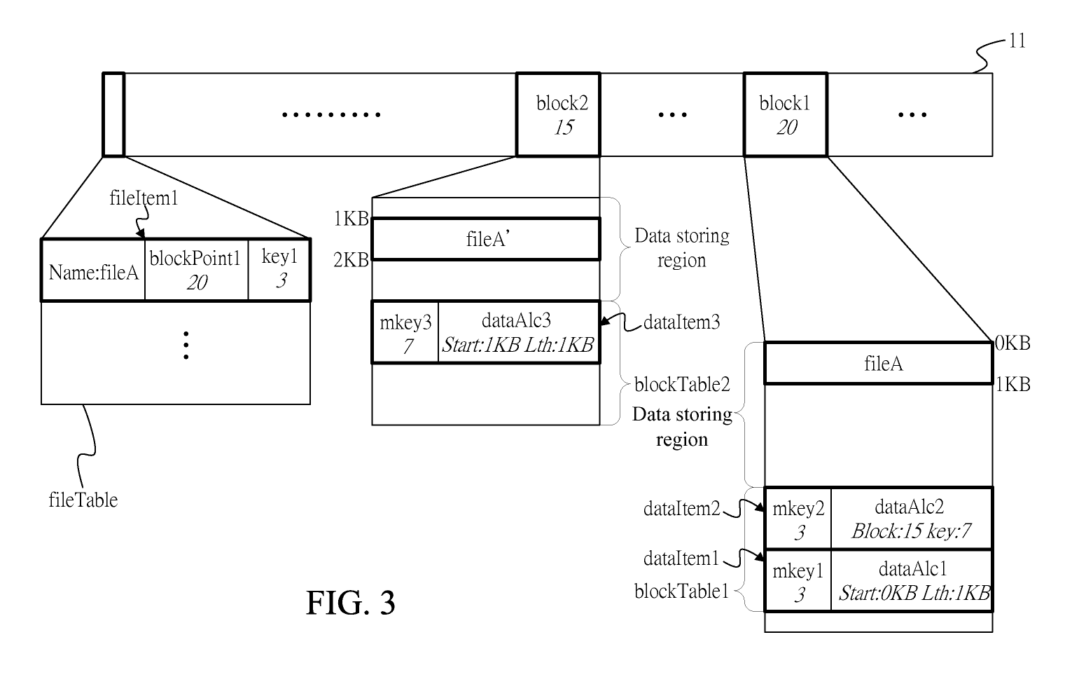

Referring to FIG. 3, there is shown a schematic view illustrating operations of the file accessing system 1 according to a third embodiment of the present invention. It should be particularly appreciated that, the third embodiment has the same architecture as the aforesaid embodiments, so elements bearing the same reference numerals also have the same functions and will not be further described herein. In the third embodiment, the first data record table blockTable1 further has a second data record item dataItem2. The second data record item dataItem2 has a second corresponding key field mKey2 and a second data allocation field dataAlc2. The third embodiment is mainly used to further describe how to store a file having an increased size.

Specifically, when the processing unit 13 determines that the file fileA is increased in size after being updated, a new portion fileA′ of the file fileA may be stored by the processing unit 13. Specifically, if the original first storing block block1 that stores the file fileA has enough space to store the new portion fileA′, then the new portion can be stored into the first storing block block1. However, if a size of the new portion fileA′ exceeds the remaining storing space of the first storing block block1, then the second data record item dataItem2 may be used for an additional allocation.

In the third embodiment, the size of the new portion fileA′ exceeds the remaining storing space of the first storing block block1, so the processing unit 13 firstly records the first key related to the file fileA into the second corresponding key field mKey2 and then decides a second storing block block2 and a second key for the new portion fileA′. Specifically, the second storing block block2 stores a second data record table blockTable2. The second data record table blockTable2 has a third data record item dataItem3. The third data record item dataItem3 has a third corresponding key field mKey3 and a third data allocation field dataAlc3.

In the third embodiment, the second storing block block2 chosen by the processing unit 13 for the new portion fileA′ is a physical storing block having a second block identification with a value of 15, and the second key has a value of 7. Accordingly, the processing unit 13 records the second block identification of the second storing block block2 and the second key into the second data allocation field dataAlc2 respectively.

Then, the processing unit 13 stores the new portion fileA′ of the file fileA into a second segment (starting from 1 KB and having a length of 1 KB) of the second storing block block2, and records the second key and the second segment into the third corresponding key field mKey3 and the third data allocation field dataAlc3 respectively at the same time. In this way, the storing of the new portion fileA′ is completed.

Similarly, if the new portion fileA′ is to be read after the storing of the new portion fileA′ of the file fileA is completed, the processing unit 13 firstly determines that a value recorded in the first corresponding key field mKey1 is the same as a value recorded in the second corresponding key field mKey2 (i.e., there are corresponding key fields having the same value in the table). Then, the processing unit 13 accesses the second data record table blockTable2 of the second storing block block2 according to the second block identification recorded in the second data allocation field dataAlc2.

Then, the processing unit 13 searches for an item having the same key value of 7 in the second data record table blcokTable2 according to the second key recorded in the second data allocation field dataAlc2. In the third embodiment, the item having the same key value of 7 is the third corresponding key field mKey3. The processing unit 13 can then access the third data allocation field dataAlc3 corresponding to the third corresponding key field mKey3. Because the second segment starting from 1 KB and having a length of 1 KB is recorded in the third data allocation field dataAlc3, the processing unit 13 can read the new portion fileA′ stored in the second segment of the second storing block block2.

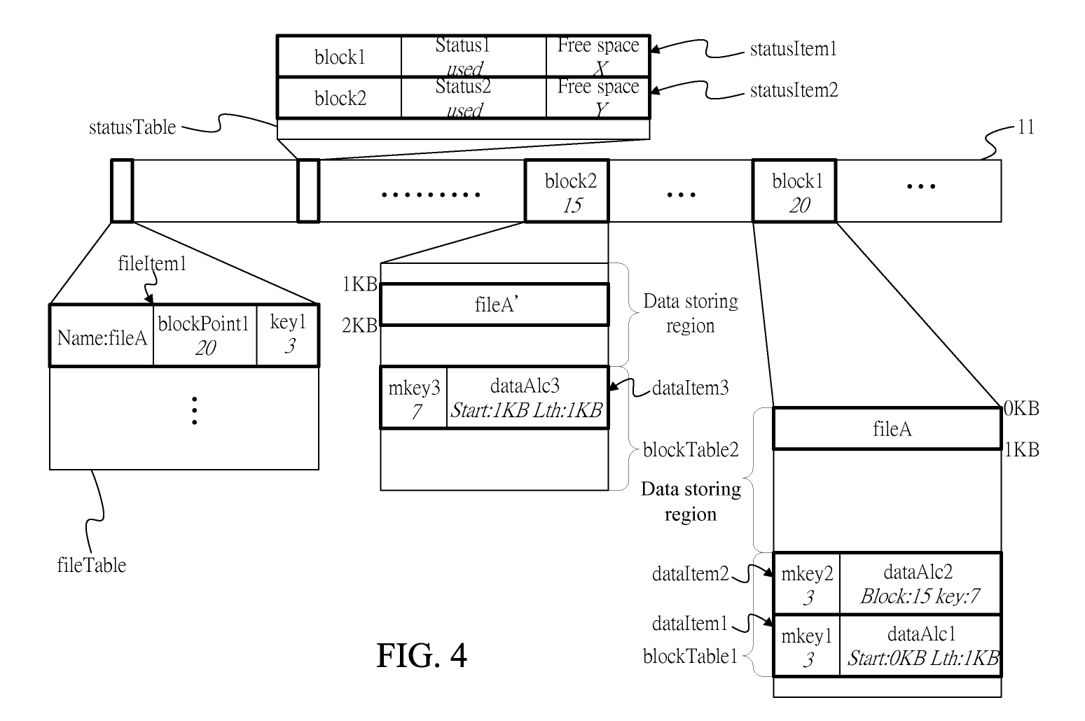

Referring to FIG. 4, there is shown a schematic view illustrating operations of the file accessing system 1 according to a fourth embodiment of the present invention. It should be particularly appreciated that, the fourth embodiment has the same architecture as the aforesaid embodiments, so elements bearing the same reference numerals also have the same functions and will not be further described herein. The fourth embodiment is mainly used to further describe how to choose a block.

Specifically, similarly in the fourth embodiment, the block usage status table statusTable further has a second block usage status item statusItem2. The second block usage status item statusItem2 records a second usage status status2 of the second storing block block2.

Similarly, when the second usage status status2 mainly records that the second storing block block2 has already been used but still has an available space Y, the processing unit 13 can then determine whether the available space Y of the second storing block block2 is large enough to store the new portion fileA′ of the file fileA. If the determination result is “yes”, then the processing unit 13 decides the second storing block block2 for the new portion fileA′ according to the second usage status status2. Otherwise, the processing unit 13 continues to search for an available storing block according to the block usage status table statusTable.

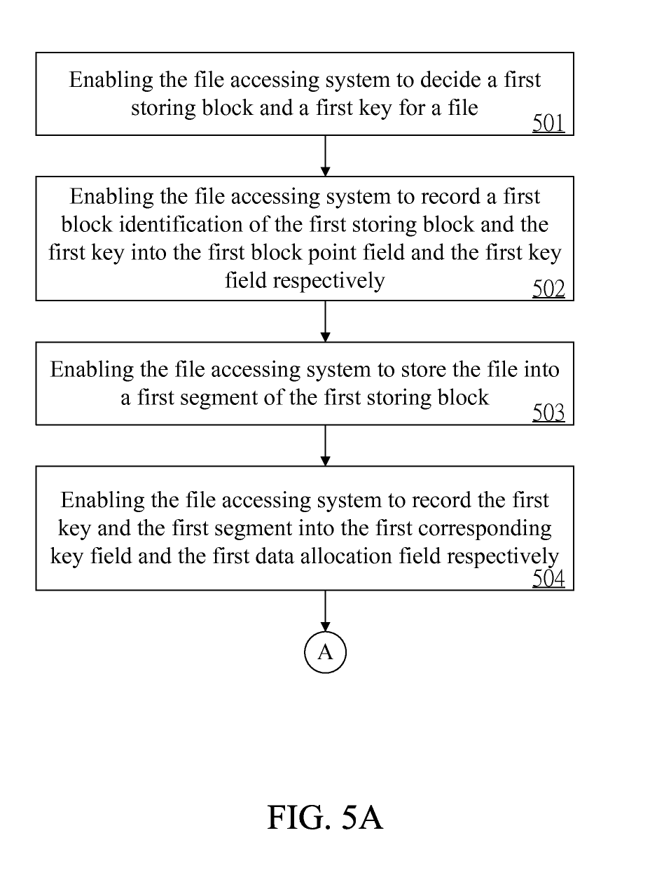

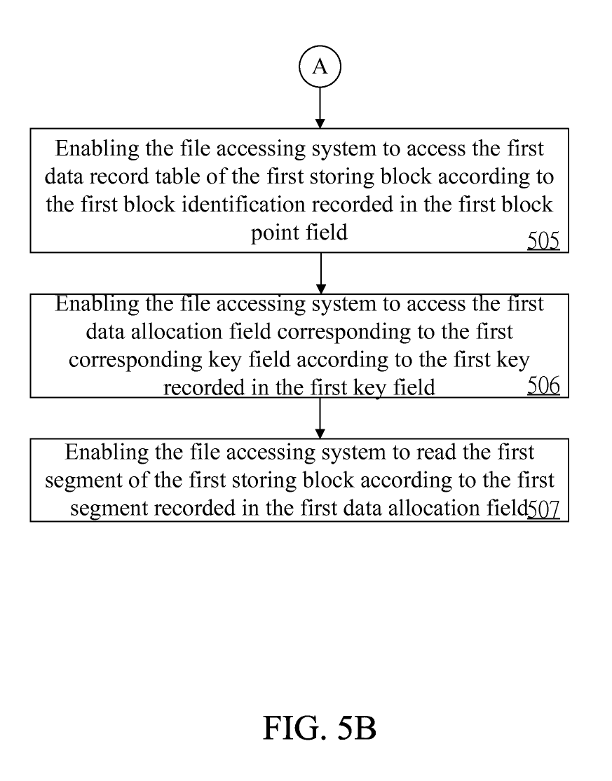

A fifth embodiment of the present invention is a file accessing method, a flowchart diagram of which is shown in FIGS. 5A-5B. The method of the fifth embodiment is used in a file accessing system (e.g., the file accessing system 1 in the aforesaid embodiments). The file accessing system stores a file accessing table. The file accessing table has a first file record item. The first file record item has a first block point field and a first key field. The steps of the fifth embodiment will be detailed hereinbelow.

Firstly, a step 501 is executed to enable the file accessing system to decide a first storing block and a first key for a file. The first storing block stores a first data record table. The first data record table has a first data record item. The first data record item has a first corresponding key field and a first data allocation field.

Then, a step 502 is executed to enable the file accessing system to record a first block identification of the first storing block and the first key into the first block point field and the first key field respectively. A step 503 is executed to enable the file accessing system to store the file into a first segment of the first storing block. A step 504 is executed to enable the file accessing system to record the first key and the first segment into the first corresponding key field and the first data allocation field respectively. In this way, the storing of the file is completed.

Similarly, if the file is to be read subsequently, a step 505 is executed to enable the file accessing system to access the first data record table of the first storing block according to the first block identification recorded in the first block point field. A step 506 is executed to enable the file accessing system to access the first data allocation field corresponding to the first corresponding key field according to the first key recorded in the first key field. Finally, a step 507 is executed to enable the file accessing system to read the first segment of the first storing block according to the first segment recorded in the first data allocation field.

It should be particularly appreciated that, the file accessing system may further store a block usage status table. The block usage status table has a first block usage status item, which records a first usage status of the first storing block. In this way, in a case where the first usage status indicates that there is still enough space to store the file in the first storing block, the file accessing system can decide to store the file into the first storing block according to the first usage status.

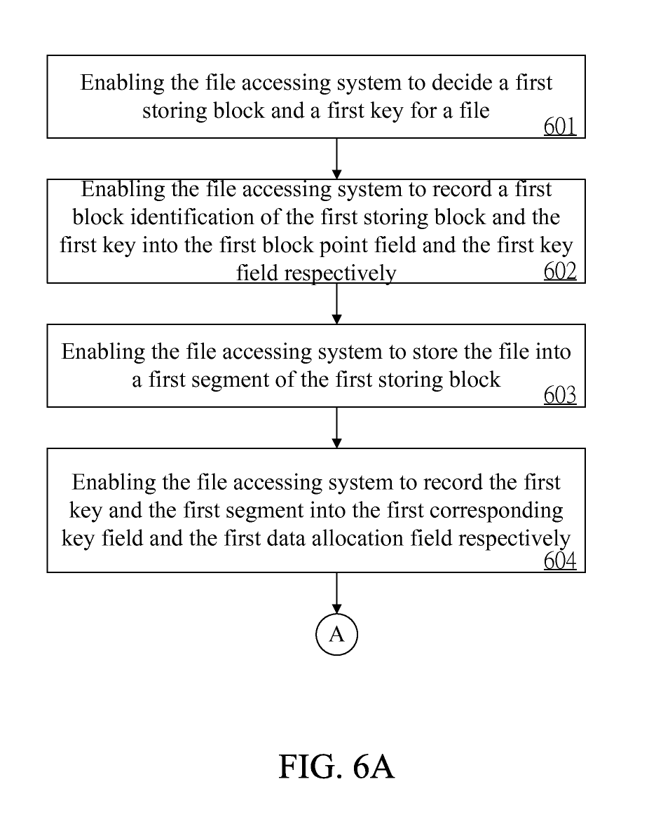

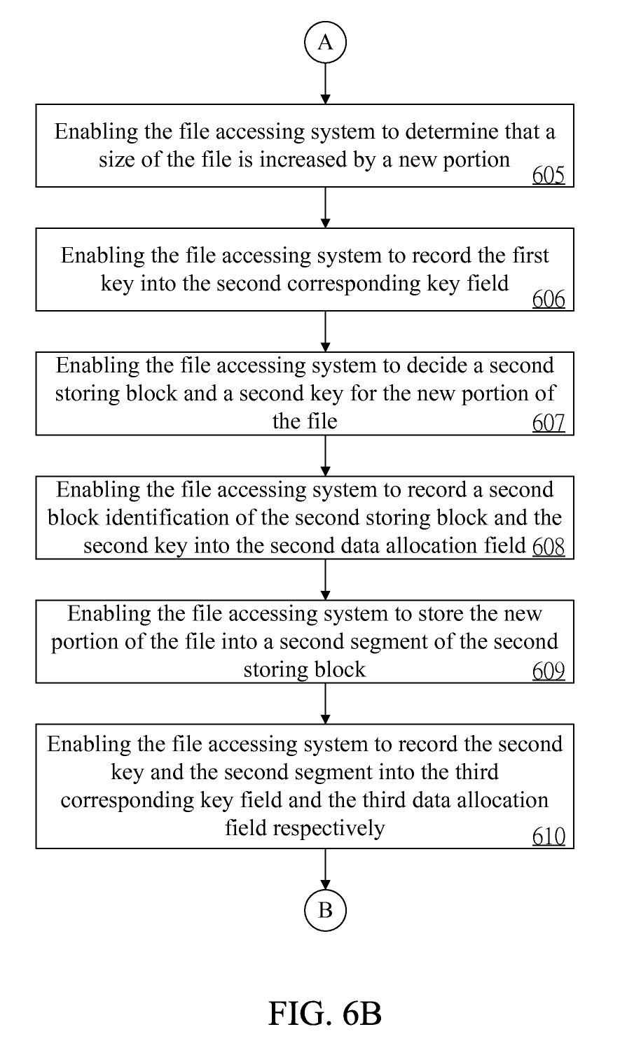

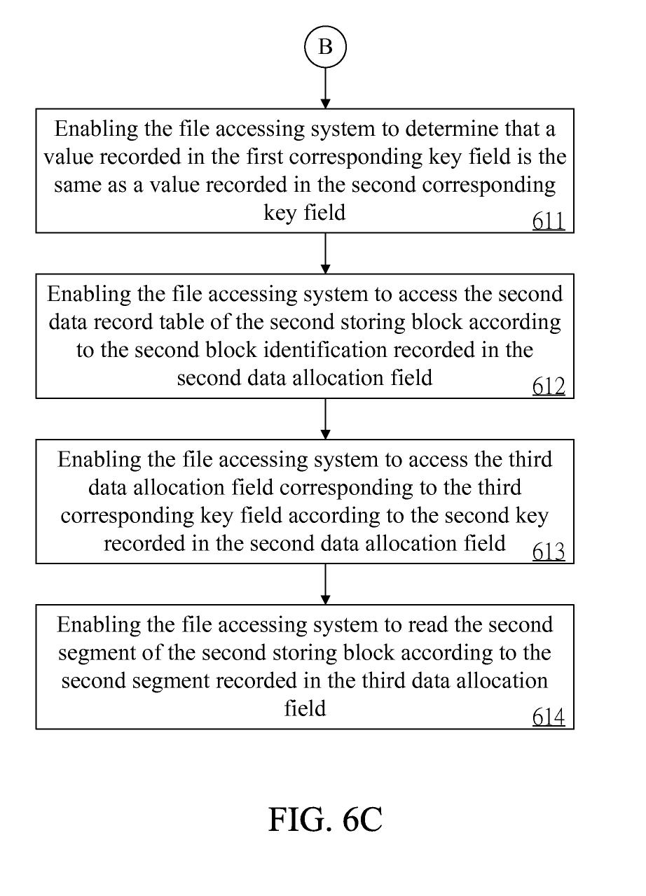

A sixth embodiment of the present invention is a file accessing method, a flowchart diagram of which is shown in FIGS. 6A-6C. The method of the sixth embodiment is used in a file accessing system (e.g., the file accessing system 1 of the aforesaid embodiments). The file accessing system stores a file accessing table. The file accessing table has a first file record item. The first file record item has a first block point field and a first key field. The steps of the sixth embodiment will be detailed hereinbelow.

Firstly, a step 601 is executed to enable the file accessing system to decide a first storing block and a first key for a file. The first storing block stores a first data record table. The first data record table has a first data record item and a second data record item. The first data record item has a first corresponding key field and a first data allocation field, and the second data record item has a second corresponding key field and a second data configuration field.

Then, a step 602 is executed to enable the file accessing system to record a first block identification of the first storing block and the first key into the first block point field and the first key field respectively. A step 603 is executed to enable the file accessing system to store the file into a first segment of the first storing block. A step 604 is executed to enable the file accessing system to record the first key and the first segment into the first corresponding key field and the first data allocation field respectively. In this way, the storing of the file is completed.

Similarly, if the file is increased in size subsequently and the original storing block does not have enough available space for the file, then the following steps should be executed to cope with this. A step 605 is executed to enable the file accessing system to determine that a size of the file is increased by a new portion. A step 606 is executed to enable the file accessing system to record the first key into the second corresponding key field.

A step 607 is executed to enable the file accessing system to decide a second storing block and a second key for the new portion of the file. The second storing block stores a second data record table. The second data record table has a third data record item. The third data record item has a third corresponding key field and a third data allocation field.

Then, a step 608 is executed to enable the file accessing system to record a second block identification of the second storing block and the second key into the second data allocation field. A step 609 is executed to enable the file accessing system to store the new portion of the file into a second segment of the second storing block. A step 610 is executed to enable the file accessing system to record the second key and the second segment into the third corresponding key field and the third data allocation field respectively. In this way, the storing of the new portion of the file is completed.

Similarly, if the new portion of the file is to be read subsequently, a step 611 is executed to enable the file accessing system to determine that a value recorded in the first corresponding key field is the same as a value recorded in the second corresponding key field. A step 612 is executed to enable the file accessing system to access the second data record table of the second storing block according to the second block identification recorded in the second data allocation field.

Then, a step 613 is executed to enable the file accessing system to access the third data allocation field corresponding to the third corresponding key field according to the second key recorded in the second data allocation field. A step 614 is executed to enable the file accessing system to read the second segment of the second storing block according to the second segment recorded in the third data allocation field. In this way, the reading of the new portion of the file is completed.

According to the above descriptions, the file accessing system and the file accessing method thereof according to the present invention can manage a file or a tail of a file that has a size smaller than that of a preset storing block in a centralized way by use of a block table. In this way, the storing space can be utilized more efficiently so as to greatly increase the using density of storing units.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A file accessing method for a file accessing system, the file accessing system storing a file accessing table which has a first file record item, and the first file record item having a first block point field and a first key field, the file accessing method comprising:
(a) the file accessing system deciding a first storing block and a first key for a file, wherein the first storing block stores a first data record table having a first data record item, and the first data record item has a first corresponding key field and a first data allocation field;
(b) the file accessing system recording a first block identification of the first storing block and the first key into the first block point field and the first key field respectively;
(c) the file accessing system storing the file into a first segment of the first storing block; and
(d) the file accessing system recording the first key and the first segment into the first corresponding key field and the first data allocation field respectively.

2. The file accessing method as claimed in claim 1, further comprising:
(e) the file accessing system accessing the first data record table of the first storing block according to the first block identification recorded in the first block point field;
(f) the file accessing system accessing the first data allocation field corresponding to the first corresponding key field according to the first key recorded in the first key field; and
(g) the file accessing system reading the first segment of the first storing block according to the first segment recorded in the first data allocation field.

3. The file accessing method as claimed in claim 1, wherein the file accessing system further stores a block usage status table having a first block usage status item, the first block usage status item records a first usage status of the first storing block, and the step (a) further comprises:
(a1) the file accessing system deciding the first storing block for the file according to the first usage status.

4. The file accessing method as claimed in claim 1, wherein the first data record table further comprises a second data record item, and the second data record item has a second corresponding key field and a second data allocation field, the file accessing method further comprising:
(e) the file accessing system determining that a size of the file is increased by a new portion;
(f) the file accessing system recording the first key into the second corresponding key field after the step (e);
(g) the file accessing system deciding a second storing block and a second key for the new portion of the file, wherein the second storing block stores a second data record table having a third data record item, and the third data record item has a third corresponding key field and a third data allocation field;
(h) the file accessing system recording a second block identification of the second storing block and the second key into the second data allocation field;
(i) the file accessing system storing the new portion of the file into a second segment of the second storing block; and
(i) the file accessing system recording the second key and the second segment into the third corresponding key field and the third data allocation field respectively.

5. The file accessing method as claimed in claim 4, further comprising:
(k) the file accessing system determining that a value recorded in the first corresponding key field is the same as a value recorded in the second corresponding key field;
(l) the file accessing system accessing the second data record table of the second storing block according to the second block identification recorded in the second data allocation field;
(m) the file accessing system accessing the third data allocation field corresponding to the third corresponding key field according to the second key recorded in the second data allocation field; and
(n) the file accessing system reading the second segment of the second storing block according to the second segment recorded in the third data allocation field.

6. The file accessing method as claimed in claim 4, wherein the file accessing system further stores a block usage status table having a second block usage status item, the second block usage status item records a second usage status of the second storing block, and the step (g) further comprises:
(g1) the file accessing system deciding the second storing block for the file according to the second usage status.

7. A file accessing system, comprising:
a storing unit, being configured to store a file accessing table which has a first file record item, the first file record item having a first block point field and a first key field; and
a processing unit, being configured to:
decide a first storing block and a first key in the storing unit for a file, wherein the first storing block stores a first data record table having a first data record item, and the first data record item has a first corresponding key field and a first data allocation field;
record a first block identification of the first storing block and the first key into the first block point field and the first key field respectively;
store the file into a first segment of the first storing block; and
record the first key and the first segment into the first corresponding key field and the first data allocation field respectively.

8. The file accessing system as claimed in claim 7, wherein the processing unit is further configured to:
access the first data record table of the first storing block according to the first block identification recorded in the first block point field;
access the first data allocation field corresponding to the first corresponding key field according to the first key recorded in the first key field; and
read the first segment of the first storing block according to the first segment recorded in the first data allocation field.

9. The file accessing system as claimed in claim 7, wherein the storing unit further stores a block usage status table having a first block usage status item, the first block usage status item records a first usage status of the first storing block, and the processing unit is further configured to decide the first storing block for the file according to the first usage status.

10. The file accessing system as claimed in claim 7, wherein the first data record table further comprises a second data record item, the second data record item has a second corresponding key field and a second data allocation field, and the processing unit is further configured to:
determine that a size of the file is increased by a new portion;
record the first key into the second corresponding key field;
decide a second storing block and a second key for the new portion of the file, wherein the second storing block stores a second data record table having a third data record item, and the third data record item has a third corresponding key field and a third data allocation field;
record a second block identification of the second storing block and the second key into the second data allocation field;
store the new portion of the file into a second segment of the second storing block; and
record the second key and the second segment into the third corresponding key field and the third data allocation field respectively.

11. The file accessing system as claimed in claim 10, wherein the processing unit is further configured to:
determine that a value recorded in the first corresponding key field is the same as a value recorded in the second corresponding key field;
access the second data record table of the second storing block according to the second block identification recorded in the second data allocation field;
access the third data allocation field corresponding to the third corresponding key field according to the second key recorded in the second data allocation field; and
read the second segment of the second storing block according to the second segment recorded in the third data allocation field.

12. The file accessing system as claimed in claim 10, wherein the file accessing system further stores a block usage status table having a second block usage status item, the second block usage status item records a second usage status of the second storing block, and the processing unit is further configured to decide the second storing block for the file according to the second usage status.
